(19) United States
(12) Patent Application Publication
(10) Pub. No.: US 2021/0323137 A1
(43) Pub. Date: Oct. 21, 2021

(54) Hammer With Vibration Reduction

(71) Applicant: APEX BRANDS, INC., Apex, NC (US)

(72) Inventor: Nicholas Ryan Imsand, Huntersville, NC (US)

(21) Appl. No.: 17/232,249

(22) Filed: Apr. 16, 2021

Related U.S. Application Data
(60) Provisional application No. 63/013,207, filed on Apr. 21, 2020.

(51) Int. Cl. B25G 1/01

(52) U.S. Cl. CPC B25G 1/01; B25D 1/04

(57) ABSTRACT

A hand tool hand may include a head and a handle. The head may have a bell and a face for delivering an impact. The handle may be operably coupled to the head and extend linearly away from the head along an axis. The handle may include a grip portion and a beam. The beam may extend from the head to the grip portion. The beam may include one or more axial passageways defining an opening through the beam in a direction substantially perpendicular to the axis. The one or more axial passageways may be filled with a first dampening material.

### TECHNICAL FIELD

Example embodiments generally relate to hand tools and, in particular, relate to a hammer that is structured to have reduced vibration during operation.

### BACKGROUND

Hand tools are commonly used across all aspects of industry and in the homes of consumers. Hand tools are employed for multiple applications including, for example, tightening, component joining, and/or the like. For some joining applications, a hammer, and particularly a hammer and nails, may be used. However, hammers are used in many other contexts as well, and are a tool that has been in use by humans for many thousands of years.

The history of hammers, like so many other tools, is a tale of continuous improvement as better materials and ways of employing those materials have advanced. From stone hammer heads with bone or wooden handles, to the replacement of the stone with stronger and stronger metals, hammers evolved significantly. Later, to improve durability, the entire hammer (i.e., the head and the handle, began to be made from metallic materials. However, in spite of the great improvement in durability, the weight of such devices and the cost in terms of relatively expensive metallic materials demanded yet further improvement.

Modern hammers are often made with combinations of materials that are meant to balance the cost and durability. However, even these modern hammers can suffer from excessive production of vibration during use. This vibration can be very stressful to the hand muscles. Moreover, prolonged vibration can cause numbness and discomfort to the user's hand. Accordingly, it may be desirable to improve hammer designs relative to the amount of vibration that such designs produce.

### BRIEF SUMMARY OF SOME EXAMPLES

In an example embodiment, a hand tool may be provided. The hand tool may include a head and a handle. The head may have a bell and a face for delivering an impact. The handle may be operably coupled to the head and extend linearly away from the head along an axis. The handle may include a grip portion and a beam. The beam may extend from the head to the grip portion. The beam may include one or more axial passageways defining an opening through the beam in a direction substantially perpendicular to the axis. The one or more axial passageways may be filled with a first dampening material.

In another example embodiment, a handle for a hand tool configured to deliver an impact may be provided. The handle may include a beam having a proximal end operably coupled to a head of the hand tool where the head is configured to deliver the impact, and a grip portion operably coupled to a distal end of the beam. The grip portion and the beam may be collinear with each other along an axis of the handle. The beam may include one or more axial passageways defining an opening through the beam in a direction substantially perpendicular to the axis. The one or more axial passageways may be filled with a first dampening material.

In another example embodiment, another method of manufacturing a hand tool is provided. The method may include forging or casting a metallic base structure comprising a head and a handle. The head may have a bell and a face for delivering an impact. The handle may be operably coupled to the head and extending linearly away from the head along an axis. The handle may further include a grip portion and a beam. The beam may extend from the head to the grip portion. The beam may include one or more axial passageways defining an opening through the beam in a direction substantially perpendicular to the axis. The method may further include filling the one or more axial passageways with a first dampening material.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a side view of a metallic base structure for formation of a hammer or similar impact delivering hand tool according to an example embodiment;

FIG. 2 is a front view of the metallic base structure of FIG. 1 in accordance with an example embodiment;

FIG. 3 is top view of the metallic base structure of FIG. 1 in accordance with an example embodiment;

FIG. 4 a front view of a hammer formed by applying dampening material into axial passageways of the metallic base structure in accordance with an example embodiment;

FIG. 5 illustrates a side view of the hammer of FIG. 4 in accordance with an example embodiment; and

FIG. 6 illustrates a block diagram of a method of making a hand tool in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may relate to the provision of a hand tool (e.g., a hammer) with an improved design that provides for the introduction of vibration reducing materials (e.g., foam, rubber, and/or other vibration dampening materials) into the handle. In this regard, for example, the vibration reducing material may be provided into a beam portion (or simply, the “beam”) of the handle, which may extend from the eye portion of the head to the grip portion. In some cases, the grip portion may also include such vibration reducing material. In any case, the vibration reducing material may be provided at least within a longitudinally extending slot formed in the beam. The resulting hammer can be produced relatively simply, and easily, but is also lighter and less susceptible to vibration, while still remaining durable and cosmetically attractive.

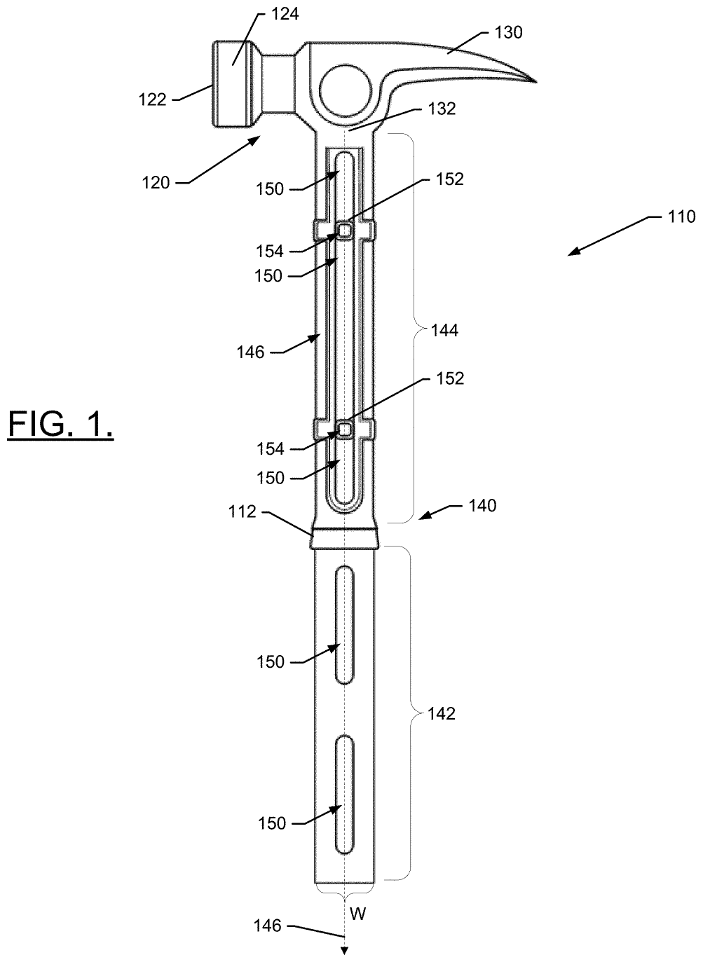

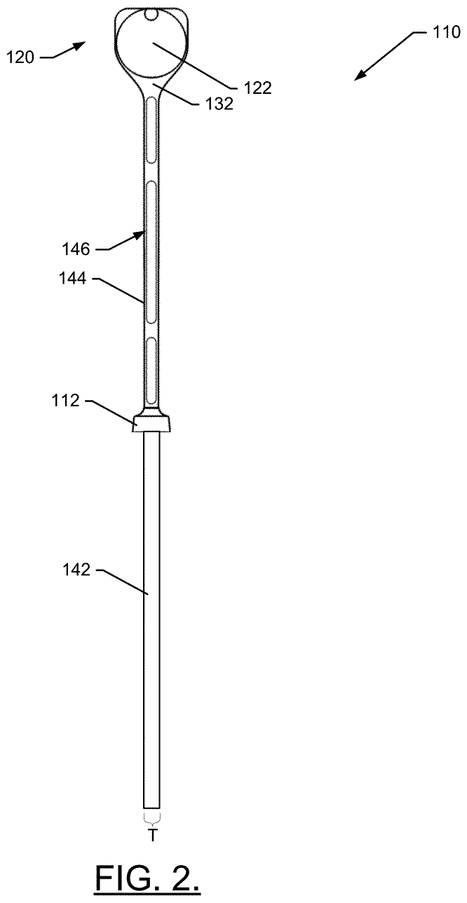

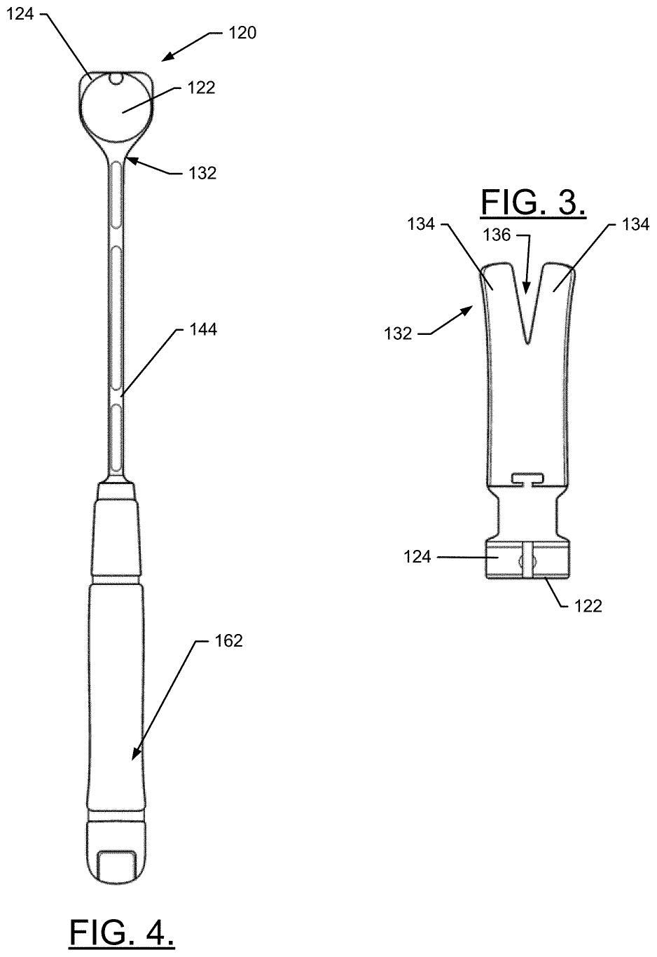

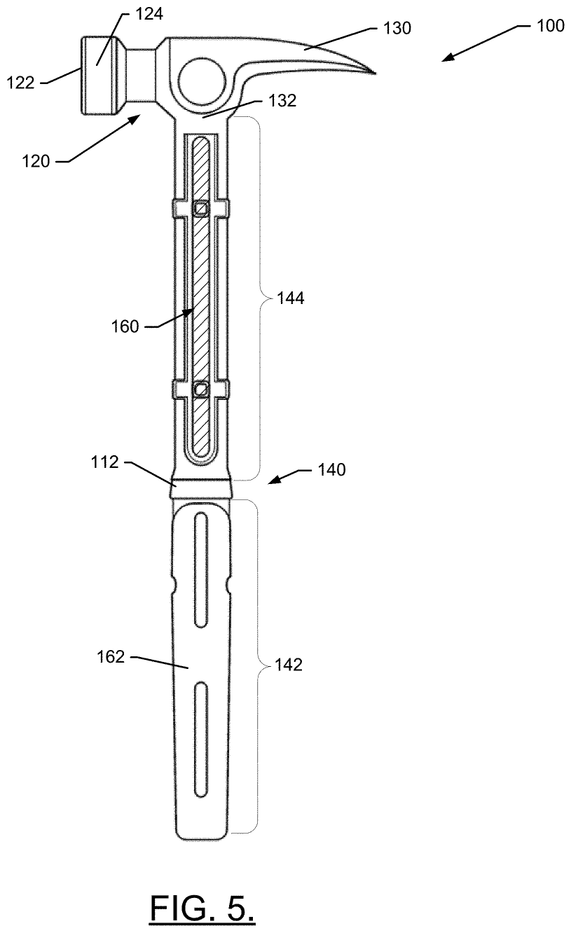

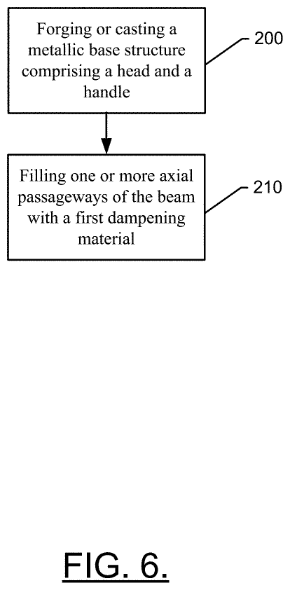

FIGS. 1-5 illustrate various views and stages associated with production of a hammer 100 according to an example embodiment. In this regard, FIG. 1 illustrates a metallic base structure 110 from the side, while FIGS. 2 and 3 show the same metallic base structure 110 from the front and top, respectively. FIGS. 4 and 5 show the hammer 100 after the metallic base structure 110 has been modified as described herein for vibration reduction.

The metallic base structure 110 may be cast or forged as a single unitary piece (although a ring 112 shown in these images may be a separate component). The metallic base structure 110 may include a head 120 and a handle 140. The head 120 may include a number of parts such as, for example, a face 122, which forms the striking surface of the hammer 100, and which is disposed at a distal end of a bell 124 of the head 120. Opposite the face 122, the head 120 may further include a claw 130. The bell 124 may be separated from the claw 130 by an eye portion 132. The lateral side of the head 120 (i.e., between the claw 130 and the bell 124, and above the eye portion 132) may be referred to as a cheek. The eye portion 132 may correspond to the eye that typically received the handle when the handle was made of a separate component or material from the head 120. However, as noted above, in this case the metallic base structure 110 is a single unitary piece so the eye portion 132 simply correlates to the location of the eye on a conventional multi-piece hammer, but does not necessarily function as such. Instead, the eye portion 132 therefore represents a point at which the handle 140 intersects with the head 120.

The claw 130 may include two laterally extending claw members 134 having a nail slot 136 formed therebetween. The head of a nail can be placed in the nail slot 136 and the claw members 134 may engage the head such that when the hammer 100 is pivoted about the eye portion 132, leverage is placed on the nail to remove the nail from the medium into which it had been driven. The claw 130 may have other uses as well, often related to prying. It should also be appreciated that the claw 130 may be replaced by a peen in some cases, and thus the particular design of the head 120 may be different in some cases without impacting other aspects of example embodiments.

The handle 140 may include a grip portion 142 and a beam portion (or beam 144). The beam 144 may extend from the eye portion 132 (at a proximal end of the beam 144) to the grip portion 142 (at a distal end of the beam 144). Thus, a proximal end of the grip portion 142 may be attached to a distal end of the beam 144, and a distal end of the grip portion 142 may extend away from the eye portion 132 and the beam 144 in alignment with the beam 144. The grip portion 142 and the beam 144 may therefore have a longitudinal centerline (or axis 146) that is common and extends away from the eye portion 132.

In some cases, both the grip portion 142 and the beam 144 may be substantially rectangular metallic plate portions. Moreover, in some cases, a width (W) of the grip portion 142 and the beam 144 may be substantially similar (or the same). Similarly, a thickness (T) may also be substantially similar (or the same) in both the grip portion 142 and the beam 144. However, the in some cases, some material may be removed from lateral edges of the grip portion 142 and/or the beam 144 in order to reduce the overall weight of the metallic base structure 110. The material may be cut, laser etched or machined away, or the handle 140 may be cast or forged to include recessed edges 146 as shown FIGS. 1 and 2. A neck or throat portion of the head 120 may also be laser etched or machined if not cast or forged. In some cases, portions of the head 120 such as the bell 124, the cheeks, the claw 130 and the eye portion 132 may be polished, and remaining portions may be coated or painted.

In an example embodiment, at least the beam 144 (and in some cases both the beam 144 and the grip portion 142) may include one or more axial passageways 150. The axial passageways 150 of this example are formed as longitudinally extending slots that are parallel to (and extend along) the axis 146. In this example, there are five distinct axial passageways 150 that are each formed as longitudinally extending slots. However, it may alternatively be possible to include fewer or more axial passageways 150 in some embodiments. Thus, for example, the axial passageways 150 could be replaced by one longitudinally extending slot extending from the proximal end of the beam 144 to the distal end of the grip portion 142. Alternatively, a single longitudinally extending slot could be provided in each of the beam 144 and the grip portion 142. As yet another alternative, the a large number of small axial passageways (including circular or other shaped axial passageways) could be formed in the beam 144 (and/or the grip portion 142). In any case, the axial passageways 150 may define an opening through the beam 144 in a direction substantially perpendicular to the axis 146. Thus, to the extent the width (W) of the beam 144 and/or grip portion 142 is wider than the thickness (T), it should be appreciated that opposing faces of the beam 144 and/or grip portion 142 that have a wider dimension (i.e., having the width (W) dimension) may lie substantially parallel to each other and the axial passageways 150 may pass through these opposing faces in a direction substantially perpendicular thereto.

In the example of FIG. 1, two distinct axial passageways 150 are formed in the grip portion 142, but only a single longitudinally extending slot is formed in the beam 144. However, within the beam 144, the longitudinally extending slot is split into three axial passageways 150 by virtue of dividers 152. The dividers 152 themselves include an orifice 154 formed therein to reduce the amount of metallic material used to form the dividers 152. The dividers 152 may provide support to the parts of the beam 144 that are on opposite sides of the axial passageways 150 and, in some cases, may have a thickness less than the thickness (T).

The axial passageways 150 provide deformation absorption for impacts to the face 122, which cause forces or vibrations to be transmitted down the handle 140. The deformation absorption is provided by each instance of the axial passageways 150, but may be enhanced by inserting a dampening material therein. Moreover, the dampening material may also perform sound dampening and/or increase impact resistance for the beam 144 (and sometimes also the grip portion 142). In some cases, the same dampening material may be used in all of the axial passageways 150. However, in other cases, a first dampening material 160 (e.g., rubber material) may be disposed on the axial passageways 150 of the beam 144, and a second dampening material (e.g., closed cell foam material) may be disposed in the axial passageways 150 of the grip portion 142. Moreover, an entirety of grip 162 may be formed entirely of the second dampening material. The grip 162 could also be formed in any desirable shape, and with various design features.

As can be appreciated from FIG. 5, the first dampening material 160 may fill the longitudinally extending slots of the axial passageways 150 of the beam 144 to a uniform thickness (less than or equal to thickness (T)). Thus, the first dampening material 160 may also fill the orifices 154 of the respective dividers 152 to enhance the grip and retention of the first dampening material 160 within the axial passageways 150. However, to further enhance such retention, an overmold material may be provided (e.g., a resin or plastic coating of any desired color or style) over the beam 144 and the first dampening material 160 to retain the first dampening material 160 within the axial passageways 150. Vibrations transmitting from the head 120 to the handle 140 may be dampened by the existence of the axial passageways 150, and further by the dampening material within the axial passageways 150. The grip 162 (excluding parts that may extend into the axial passageways 150) may provide additional vibration reduction. Similarly, if an overmold is employed, the overmold material may also dampen vibrations.

FIG. 5 illustrates a block diagram of a method of manufacturing a hand tool according to example embodiments. The method may include forging or casting a metallic base structure comprising a head and a handle at operation 200. The head may have a bell and a face for delivering an impact. The handle may be operably coupled to the head and extending linearly away from the head along an axis. The handle may further include a grip portion and a beam. The beam may extend from the head to the grip portion. The beam may include one or more axial passageways defining an opening through the beam in a direction substantially perpendicular to the axis. The method may further include filling the one or more axial passageways with a first dampening material at operation 210.

Accordingly, a hand tool of an example embodiment may include a head and a handle. The head may have a bell and a face for delivering an impact. The handle may be operably coupled to the head and extend linearly away from the head along an axis. The handle may include a grip portion and a beam. The beam may extend from the head to the grip portion. The beam may include one or more axial passageways defining an opening through the beam in a direction substantially perpendicular to the axis. The one or more axial passageways may be filled with a first dampening material.

The hand tool (or simply the handle thereof) may include a number of modifications, augmentations, or optional additions, some of which are described herein. The modifications, augmentations or optional additions may be added in any desirable combination. For example, the grip portion may further include at least one axial passageway, and a second dampening material may be disposed in the at least one axial passageway. In an example embodiment, the first and second dampening materials may be the same material or different materials. In some cases, the first and second dampening materials may be rubber or closed cell foam. In an example embodiment, a grip may be formed on the grip portion, and the grip may be made from the second dampening material. In some cases, the one or more axial passageways may be defined as longitudinally extending slots that are parallel to or aligned with the axis. In an example embodiment, a divider may separate the longitudinally extending slots, and the divider may have an orifice passing therethrough. The first dampening material may extend into the orifice. In some cases, a thickness of the first dampening material may be less than or equal to a thickness of the beam. In an example embodiment, the head, the beam and the grip portion may be made from a single unitary piece of metal.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A hand tool comprising:
a head having a bell and a face for delivering an impact; and
a handle operably coupled to the head and extending linearly away from the head along an axis,
wherein the handle comprises a grip portion and a beam, the beam extending from the head to the grip portion,
wherein the beam comprises one or more axial passageways defining an opening through the beam in a direction substantially perpendicular to the axis, and
wherein the one or more axial passageways are filled with a first dampening material.

2. The hand tool of claim 1, wherein the grip portion further comprises at least one axial passageway, and
wherein a second dampening material is disposed in the at least one axial passageway.

3. The hand tool of claim 2, wherein the first and second dampening materials are a same material.

4. The hand tool of claim 2, wherein the first and second dampening materials are different materials.

5. The hand tool of claim 2, wherein the first and second dampening materials are rubber or closed cell foam.

6. The hand tool of claim 2, wherein a grip is formed on the grip portion, and
wherein the grip is made from the second dampening material.

7. The hand tool of claim 1, wherein the one or more axial passageways are defined as longitudinally extending slots that are parallel to or aligned with the axis.

8. The hand tool of claim 7, wherein a divider separates the longitudinally extending slots,
wherein the divider has an orifice passing therethrough, and
wherein the first dampening material extends into the orifice.

9. The hand tool of claim 1, wherein a thickness of the first dampening material is less than or equal to a thickness of the beam.

10. The hand tool of claim 1, wherein the head, the beam and the grip portion are made from a single unitary piece of metal.

11. A handle for a hand tool configured to deliver an impact, the handle comprising:
a beam having a proximal end operably coupled to a head of the hand tool, the head being configured to deliver the impact; and
a grip portion operably coupled to a distal end of the beam, the grip portion and the beam being collinear along an axis of the handle,
wherein the beam comprises one or more axial passageways defining an opening through the beam in a direction substantially perpendicular to the axis, and
wherein the one or more axial passageways are filled with a first dampening material.

12. The handle of claim 11, wherein the grip portion further comprises at least one axial passageway, and
wherein a second dampening material is disposed in the at least one axial passageway.

13. The handle of claim 12, wherein the first and second dampening materials are a same material or different materials.

14. The handle of claim 12, wherein the first and second dampening materials are rubber or closed cell foam.

15. The handle of claim 12, wherein a grip is formed on the grip portion, and
wherein the grip is made from the second dampening material.

16. The handle of claim 11, wherein the one or more axial passageways are defined as longitudinally extending slots that are parallel to or aligned with the axis.

17. The handle of claim 16, wherein a divider separates the longitudinally extending slots,
wherein the divider has an orifice passing therethrough, and
wherein the first dampening material extends into the orifice.

18. The handle of claim 11, wherein a thickness of the first dampening material is less than or equal to a thickness of the beam.

19. The handle of claim 11, wherein the head, the beam and the grip portion are made from a single unitary piece of metal.

20. A method of manufacturing a hand tool, the method comprising:
forging or casting a metallic base structure comprising a head and a handle, the head having a bell and a face for delivering an impact, and the handle being operably coupled to the head and extending linearly away from the head along an axis, the handle further comprising a grip portion and a beam, the beam extending from the head to the grip portion, the beam comprising one or more axial passageways defining an opening through the beam in a direction substantially perpendicular to the axis, and
filling the one or more axial passageways with a first dampening material.
